(19) United States
(12) Patent Application Publication
(10) Pub. No.: US 2013/0254372 A1
(43) Pub. Date: Sep. 26, 2013

(54) COMPUTER ACTIVITY MONITORING DEVICE

(71) Applicant: Whitney Pierce, Roanoke, VA (US)

(72) Inventor: Whitney Pierce, Roanoke, VA (US)

(21) Appl. No.: 13/424,637

(22) Filed: Mar. 20, 2012

(51) Int. Cl. G06F 11/00

(52) U.S. Cl. 709/224

(57) ABSTRACT

A monitoring device for indicating computing activities occurring at a computing device is provided. A control module receives signals from the computing device. The signals correspond to an activity state of the computing device. A first visual indicator is coupled to the control module. The control module activates the first visual indicator in response to receipt of a signal corresponding to an approved activity state. A second visual indicator is also coupled to the control module. The control module activates the second visual indicator in response to receipt of a signal corresponding to an unapproved activity state.

### FIELD OF THE INVENTION

This invention relates to computer monitoring and in particular to computer peripherals that monitor computing activities occurring at a computing device.

### BACKGROUND

The use of personal computing systems such as laptops and tablet computers has become increasingly common in classroom settings. Students may use these computing systems to take notes, read course materials, or access online resources in conjunction with classroom instruction. In many circumstances, however, students frequently use the computing systems to engage in activities unrelated to classroom instruction—a frequent and understandable complaint of instructors.

Instead of paying attention or contributing to classroom instruction, students may, for example, browse websites, play video games, access social networks, or chat with friends. These types of activities may be distracting to the students themselves, the instructors, and any neighboring students in the field of view of such activities. Therefore, a need exists for an approach to quickly and effectively identify the computing activities occurring at a computing device.

### SUMMARY

A monitoring device for indicating computing activities occurring at a computing device is provided. A control module receives signals from the computing device. The signals correspond to an activity state of the computing device. A first visual indicator is coupled to the control module. The control module activates the first visual indicator in response to receipt of a signal corresponding to an approved activity state. A second visual indicator is also coupled to the control module. The control module activates the second visual indicator in response to receipt of a signal corresponding to an unapproved activity state.

A computer-implemented method of indicating computing activities occurring at a computing device is also provided. Signals are received from the computing device. The signals correspond to an activity state of the computing device. A first visual indicator is automatically activated in response to receipt of a signal corresponding to an approved activity state. A second visual indicator is automatically activated in response to receipt of a signal corresponding to an unapproved activity state.

Another monitoring device for indicating the computing activities occurring at a computing device is further provided. A micro controller receives signals from a driver module that resides at the computing device. The driver module monitors the computing activities occurring at the computing device. The driver module also determines an activity state of the computing device by determining whether the computing activities are approved computing activities or unapproved computing activities. The driver module transmits to the microcontroller a signal corresponding to the activity state of the computing device. A connector is coupled to the microcontroller, and the connector is attachable to an input-output port (I/O) of the computing device. The microcontroller receives the signals from the driver module via the I/O port and the connector. The monitoring device also includes three light-emitting diodes (LEDs) respectively coupled to the microcontroller. The microcontroller activates the first LED in response to receipt of a signal corresponding to an approved activity state such that the first LED visually communicates to an observer that approved computing activities are occurring at the computing device. The microcontroller activates the second LED in response to receipt of a signal corresponding to an unapproved activity state such that the second LED visually communicates to the observer that unapproved computing activities are occurring at the computing device. The microcontroller activates the third LED when the activity state of the computing device cannot be deten lined. The monitoring device additionally includes an audio output device that emits a sound when the monitoring device is detached from the computing device.

### BRIEF DESCRIPTION OF THE DRAWINGS

The invention will be described with reference to the following figures. The components in the figures are not necessarily to scale, emphasis instead being placed upon illustrating the principles of the invention. Moreover, like reference numerals in the figures designate corresponding parts throughout the different views.

FIG. 1 is a block diagram of an example of an implementation of a computer activity monitoring device.

FIG. 2 is another block diagram of an example of an implementation of a computer activity monitoring device.

FIG. 3A is an example of an implementation of a computer activity monitoring device indicating an unknown activity state.

FIG. 3B is an example of an implementation of a computer activity monitoring device indicating an approved activity state.

FIG. 3C is an example of an implementation of a computer activity monitoring device indicating an unapproved activity state.

FIG. 4A is a view of an example method of use of multiple computer activity monitoring devices in a classroom setting where each device respectively indicates an approved activity state.

FIG. 4B is a view of an example method of use of multiple computer activity monitoring devices in a classroom setting where one of the devices indicates an unapproved activity state.

FIG. 5 is a flowchart of example method steps for monitoring the computing activities occurring at a computer device.

### DETAILED DESCRIPTION

A computer activity monitoring device and method of monitoring the computing activities occurring at a computing device are provided. The computer activity monitoring device (“activity monitor”) is coupled (i.e., attached) to a computing device. Based on the computing activities occurring at the computing device, the activity monitor activates a visual indicator to visually communicate whether approved or unapproved activities are occurring at the computing device.

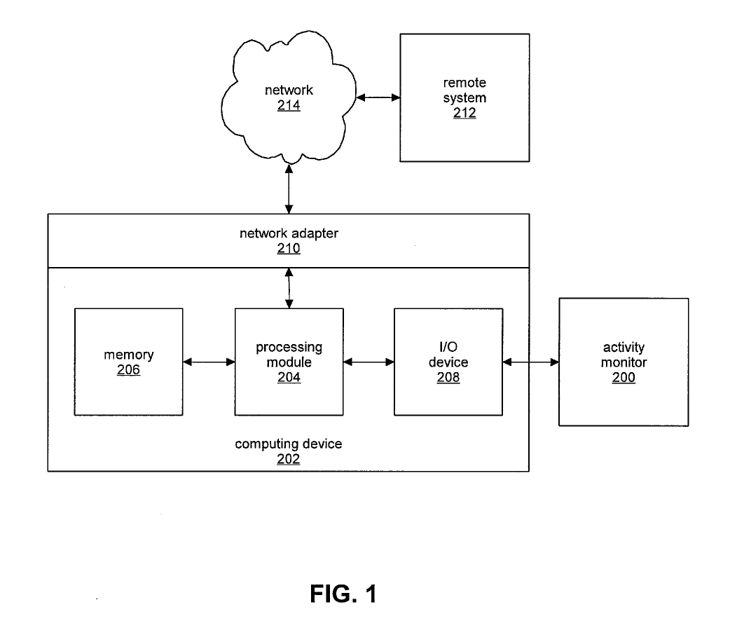

Referring to FIG. 1, a block diagram of an example of an implementation of an activity monitor 200 is shown. The activity monitor 200 is attached to a computing device 202 to monitor the computing activities occurring at the computing device. The computing device 202 may be, for example, a desktop computer, a laptop computer, a tablet computer, a palmtop computer, a cellular telephone, and other devices configured to carry out computing-related tasks. Accordingly the computing device 202 may include components common to computing devices including a processing module 204, a memory 206, and an input-output (I/O) device 208. The computing device 202 may also be network-enabled and thus also include a network adapter 210 for communicating with a remote system 212 over a network 214. The network adapter 210 may be a wired or wireless adapter and may include both a wired network adapter and a wireless network adapter. The remote system 212 may be another computing device such as, for example, a file server or web server. The network 214 may be a wireless or wired network and include, for example, a local area network (LAN) or a wide area network (WAN) such as the Internet.

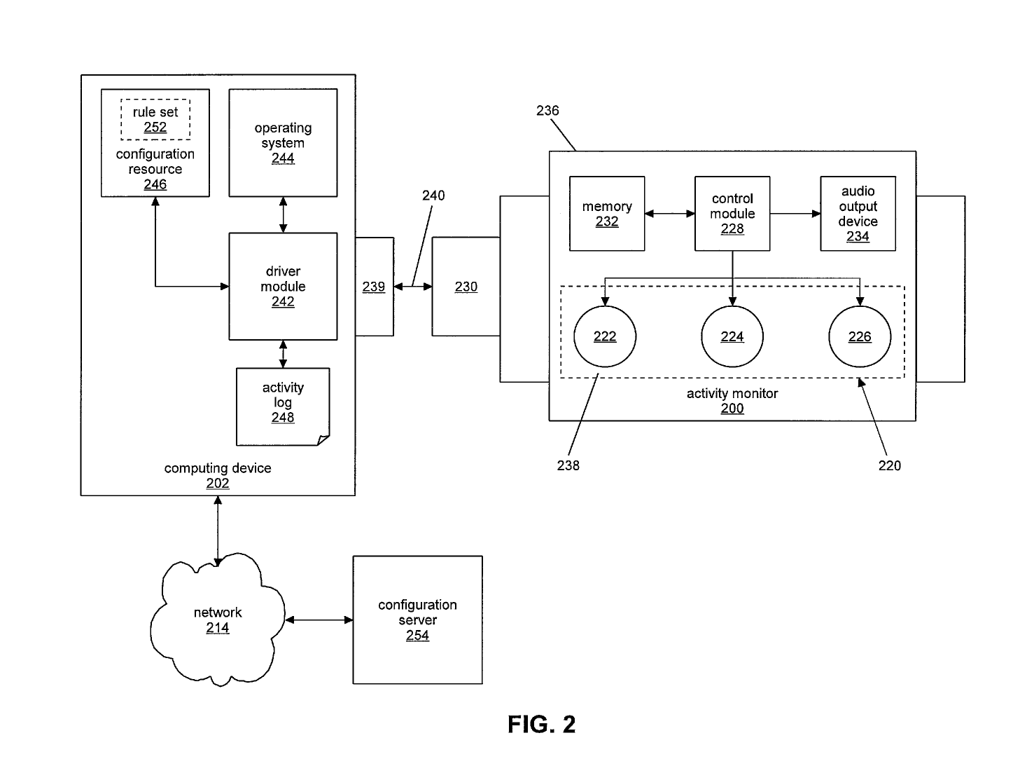

Referring now to FIG. 2, another block diagram of an example of an implementation of an activity monitor 200 is shown. As seen in FIG. 2, the activity monitor 200 includes: a set 220 of visual indicators 222, 224, and 226 that visually indicate the activity state of a computing device 202; a control module 228 that controls the activation state of the visual indicators; and a connector 230 that attaches the activity monitor to the computing device. The activity monitor 200 may also include a memory 232 and an audio output device 234 as discussed further below. The set 220 of visual indicators 222, 224, and 226 along with the control module 228, the audio output device 234, and the memory 232 may reside within a housing 236. Furthermore, I/O-related and control circuitry (not shown) may couple the control module 228 to the connector 230, the memory 232, the audio output device 234, and the set 220 of visual indicators 222, 224, and 226.

The memory 232 may be, for example, a flash memory. Additionally, the control module 228 and the memory 232 may be implemented, e.g., as a microcontroller residing at the activity monitor 200. The housing 236 of the activity monitor 200 may be formed, for example, of plastic or any other material suitable to contain and protect the internal components of the activity monitor.

The visual indicators 222, 224, and 226 may be light-emitting diodes (LEDs) that respectively correspond to an activity state of the computing device 202. Additional or alternative types of visual indicators 222, 224, and 226 or light-emitting components suitable for visually communicating the activity state of the computing device 202 may be selectively employed. The activity monitor 200 may include three visual indicators 222, 224, and 226 where each visual indicator respectively corresponds to one of three activity states: unknown, approved, and unapproved. An alternative number of visual indicators and corresponding activity states may be selectively employed. Furthermore, the activity states may respectively correspond to a particular color of visual indicator. A green visual indicator 224 may correspond to an approved activity state; a red visual indicator 226 may correspond to an unapproved activity state; and a yellow visual indicator 222 may correspond to an unknown activity state. Alternative colors may be selectively employed to visually communicate whether approved or unapproved computing activities are occurring at the computing device 202.

The visual indictors 222, 224, and 226 may be arranged within the housing 236 of the activity monitor 200 such that the visual indicators are visible from most orientations relative to the activity monitor. For example, the visual indicators 222, 224, and 226 may be arranged within the housing 236 of the activity monitor 200 such that the visual indicators are visible in front of, behind, and to the side of the activity monitor. Accordingly, the activity monitor 200 may include a translucent section 238 through which an observer may view the visual indicators 222, 224, and 226.

Based on the computing activities occurring at the computing device 202, the control module 228 of the activity monitor 200 activates or deactivates the visual indicators 222, 224, and 226. If the computing activities occurring at the computing device 202 are approved computing activities, then the control module 228 may activate an approved visual indicator 224. If the computing activities occurring at the computing device 202 are unapproved, then the control module 228 may activate an unapproved visual indicator 226. If the activity state of the computing device 202 cannot be determined or is unknown, then the control module 228 may activate an unknown visual indicator 222. In this way, an observer may quickly determine whether the computing activities occurring at the computing device 202 are approved or unapproved computing activities. Moreover, because the activity monitor 200 visually communicates the activity state of the computing device 202, an observer may advantageously determine the activity state of the computing device when observing the activity monitor from a distance.

The activity monitor 200 may be attached to the computing device 202 via a connector 230. The I/O device 208 of the computing device 202 may include an I/O port 239 (i.e., a communication port) configured to receive the connector 230 of the activity monitor 200. The activity monitor 200 and the computing device 202 may exchange signals 240 (i.e., communications) via the connector 230 and the I/O port 239. The connector 230 of the activity monitor 200 may be, for example, a universal serial bus (USB) connector, and the I/O port 239 of the I/O device 208 may be a corresponding USB port. Other types of connectors and ports suitable for exchanging electronic communications may be selective employed.

The activity monitor 200 may communicate with a driver module 242 (“host driver”) that resides at the computing device 202 and monitors the activities occurring at the computing device. The host driver 242 operates as an I/O driver and exchanges communications 240 with the control module 228 of the activity monitor. Communications 240 may include, for example, signals from the host driver 242 to the control module 228 that instruct the control module to activate one of the visual indicators 222, 224, or 226. Communications 240 may also include status signals and authentication information as discussed further below. The host driver 242 classifies the computing activities occurring at the computing device 202 to determine the activity state of the computing device, e.g., approved, unapproved, or unknown. The host driver 242 determines the activity state of the computing device 202 and then transmits a signal 240 to the control module 228 of the activity monitor 200 that corresponds to the activity state of the computing device. In response to receipt of the signal 240 from the host driver 242, the control module 228 activates the visual indicator 222, 224, or 226 that corresponds to the activity state of the computing device 202. The control module 228 may also deactivate any visual indicators 222, 224, and 226 that do not correspond to the activity state of the computing device 202.

The host driver 242 may communicate with the operating system 244 of the computing device 202 in order to monitor the computing activities occurring at the computing device. The host driver 242 may also access a configuration resource 246 and an activity log 248 that also reside at the computing device 202 as discussed further below.

Various approaches may be selectively employed for installing the host driver 242 at the computing device 202. The host driver 242 may be downloaded (i.e., pulled) from a remote system 212 (e.g., a file server or a web server) over a network 214 (e.g., a LAN or WAN). The host driver 242 may be delivered to the computing device 202 via installation media, e.g., a CD (compact disc), a DVD (digital versatile disc), a diskette, a flash memory device, or other data storage device suitable for storing the host driver and delivering the host driver to the computing device. The host driver 242 may also be installed at the computing device 202 automatically via an installation software application that is downloaded or delivered by installation media. The host driver 242 may be deployed (i.e., pushed) to the computing device 202 from a central management system coupled with the computing device over a network 214. The host driver may also be bundled with the operating system 244 of the computing device 202.

In one example implementation, the host driver 242 may be delivered to the computing device 202 by the activity monitor 200 itself. The host driver 242, in this example, may reside in the memory 232 of the activity monitor 200. When the activity monitor 200 is attached to the computing device 202, the activity monitor may determine whether the host driver 242 is installed at the computing device. If the activity monitor 200 determines that the host driver 242 is not installed at the computing device 202, then the activity monitor may transmit the host driver to the computing device for installation. Once the host driver 242 is installed at the computing device 202, the host driver may monitor the computing activities occurring at the computing device and transmit signals 240 to the activity monitor 200 that correspond to the activity state of the computing device.

In another example implementation, the activity monitor 200 may store an installation package that installs the host driver 242 at the computing device 202. The activity monitor 200, in this example, may identify itself to the computing device 202 as a simple storage device (e.g., a USB flash drive) upon attachment. A user at the computing device 202 may then execute the installation package to install the host driver 242 from the activity monitor 200 at the computing device. Once the host driver 242 is installed, the host driver may transmit a signal 240 to the activity monitor 200 such that the activity monitor changes modes and subsequently identifies itself to the computing device 202 as an activity monitor rather than a simple storage device.

Once the host driver 242 is installed at the computing device 202, the host driver hooks into the operating system 244 to communicate with the operating system in order to monitor the computing activities occurring at the computing device. It will be understood that various approaches may be selectively employed to configure the host driver 242 to communicate with the operating system 244 that depend on, for example, the type of operating system running at the computing device 202. On a Windows® platform, for example, the host driver 242 may be implemented, at least in part, as a “filter-hook” driver to monitor network activity at the computing device 202. Accordingly, the operating system 244 may insert the host driver 242 into the network stack allowing the host driver to analyze network traffic occurring at the network adapter 210. It will be understood the methods of accessing network traffic may vary between different types of operating systems.

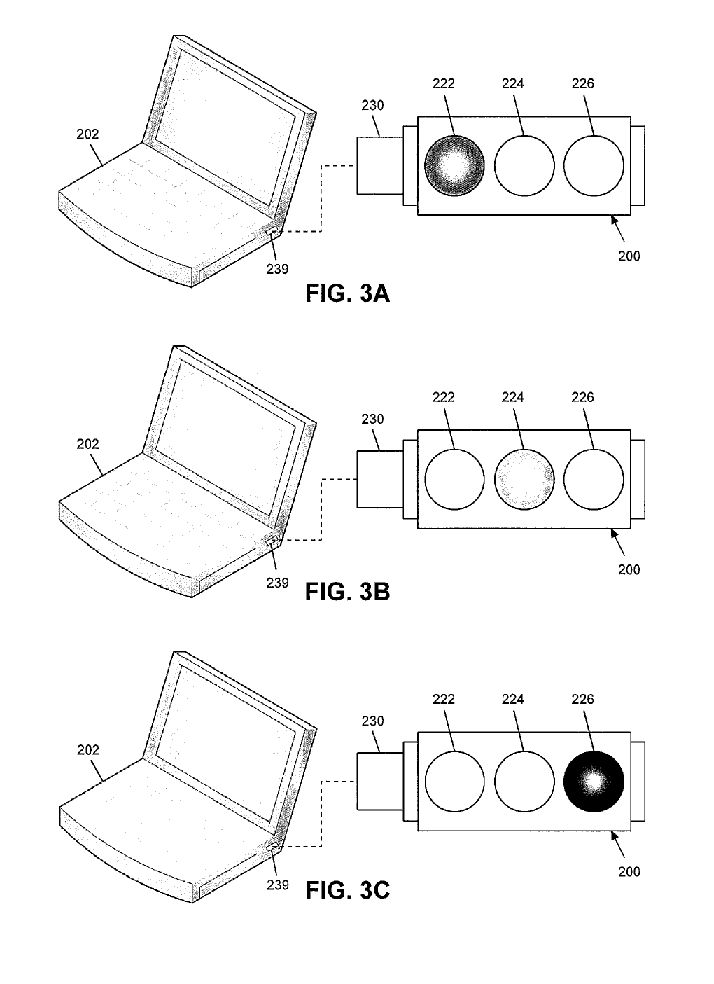

The computer monitoring process will now be discussed with reference to FIGS. 3A-C. After the host driver 242 is installed at the computing device 202, the host driver waits for the activity monitor 200 to be attached to the computing device 202. The operating system 244, in this example, notifies the host driver 242 when the activity monitor 200 is attached to the computing device 202. While the activity monitor 200 is attached to the computing device 202, the activity monitor, in this example, receives power from the computing device 202 via the connector 230 and I/O port 239.

The host driver 242 and the activity monitor 200 may also perform an initialization procedure when the activity monitor is first attached to the computing device 202. During the initialization procedure, the activity monitor 200 attempts to establish a communication link with the host driver 242 residing at the computing device 202. The control module 228 of the activity monitor 200 may activate the unknown visual indicator 222 upon receipt of the power signal from the computing device 202. The control module 228 may keep the unknown visual indicator 222 activated for the duration of the initialization procedure as the communication link with the host driver 242 is established.

As seen in FIG. 3A, the unknown indicator 222 of the activity monitor 200 is activated, which may indicate that the activity monitor is performing the initialization procedure or that the activity state of the computing device 202 cannot be determined. In FIG. 3A, the unknown visual indicator 222 is shown to be activated using a medium-gray gradient. If the unknown visual indicator 222 remains activated at the conclusion of the initialization procedure, then an observer may conclude that a problem exists with the computing device 202, the activity monitor 200, or both. A persistent unknown visual indicator 222 may indicate, for example, that the host driver 242 is not installed at the computing device 202, that the computing device is damaged, or that the activity monitor 200 itself is damaged.

The initialization procedure may also include an authentication procedure once the activity monitor 200 establishes the communication link with the host driver 242. The activity monitor 200 and the host driver 242 may attempt to authenticate one another in order to ensure a trusted communication exchange during the computer activity monitoring process. The authentication procedure may include, for example, the computation and exchange of cryptographic or obfuscated information between the host driver 242 and the control module 228. The authentication procedure may ensure that the host driver 242 has not been tampered with or compromised, e.g., by being replaced with an alternative host driver.

One example of an authentication procedure that may be selectively employed is a Diffie-Hellman key exchange, which computes a shared encryption key that the host driver 242 and activity monitor 200 use to encrypt and decrypt exchanged communications 240. Another example of an authentication procedure that may be selectively employed uses an RSA (Rivest Shamir Adleman) private key stored at the activity monitor 200 and a corresponding public key stored at the computing device 202 that is accessible to the host driver 242. The activity monitor 200, in this example, may encrypt the communications 240 transmitted to the host driver 242 using the private key, and the host driver may decrypt the received communications using the public key. Likewise, the host driver 242 may encrypt the communications 240 transmitted to the activity monitor 200 using the public key, and the activity monitor may decrypt received communications using the private key. By encrypting the communications 240 exchanged between the host driver 242 and activity monitor 200, users may be dissuaded from tampering with the host driver 242, the activity monitor 200, or any exchanged communications.

If the authentication process fails, then the control module 228 of the activity monitor 200 may activate the unapproved visual indicator 226. The authentication process may fail if, e.g.: the host driver 242 cannot authenticate the activity monitor 200; the activity monitor cannot authenticate the host driver; or the host driver and activity monitor cannot authenticate each other.

If the authentication procedure succeeds, then the host driver 242 begins to monitor the computing activities occurring at the computing device 202, and the activity monitor 200 waits to receive signals 240 from the host driver that correspond to the activity state of the computing device. During the monitoring process, the host driver 242 and the activity monitor 200 may exchange status signals 240 at a periodic interval (e.g., once a second) to ensure the communication link between the host driver and the activity monitor remains active. If the activity monitor 200 determines that the communication link has dropped (i.e., has timed out or has been lost), then the control module 228 may activate the unknown visual indicator 222, as shown in FIG. 3A, while the activity monitor 200 attempts to reestablish the communication link with the host driver 242.

As seen in FIG. 3B, the activity monitor 200 has activated the approved visual indicator 224, which indicates that the computing activities occurring at the computing device are approved computing activities. In FIG. 3B, the approved visual indicator 224 is shown to be activated using a light-gray gradient. When approved computing activities are occurring at the computing device 202, the host driver 242 may periodically transmit signals 240 to the control module 228 of the activity monitor 200 corresponding to the approved activity state in order to ensure the approved visual indicator 224 remains active. When the host driver 242 determines that unapproved computing activities are occurring at the computing device 202, however, the host driver may transmit a signal 240 to the control module 228 of the activity monitor 200 that corresponds to an unapproved activity state. In response to receipt at the activity monitor 200 of the signal 240 that corresponds to an unapproved activity state, the control module 228 may deactivate the approved visual indicator 222 and activate the unapproved visual indicator 226 as shown in FIG. 3C. The unapproved visual indicator 226 in FIG. 3C is shown to be activated using a dark-gray gradient.

The visual indicators 222, 224, and 226 may remain a solid color when activated. Additionally or alternatively, the visual indicators 222, 224, and 226 may blink when activated. The activity monitor 200 may also keep the unapproved visual indicator 226 activated for a predetermined countdown period (e.g., 10 minutes) even if the unapproved computing activity at the computing device 202 has ceased. A blinking unapproved visual indicator 226 may be employed, for example, to indicate that the unapproved computing activity has ceased but that the countdown period has not yet expired. It will be understood that additional or alternative lighting patterns may be selectively employed to visually communicate the activity state of the computing device 202.

The host driver 242 may also maintain an activity log 248 at the computing device 202 as mentioned above with reference to FIG. 2. The host driver 242 may update the activity log 248 when various computing monitoring events occur. The host driver 242 may add log entries to the activity log 248 when, for example: the activity monitor 200 is attached to the computing device 202; the activity monitor is detached from the computing device; the communication link between the host driver and the activity monitor is established; the communication link between the host driver and the activity monitor is lost; and the activity state of the computing device changes. The activity log 248 may be, for example, a text file that includes respective line item entries for each computer monitoring event. The line item entries may include a timestamp of when the event occurred and details that describe the event.

As mentioned above, the host driver 242 may be configured to determine when approved and unapproved computing activities occur at the computing device 202. Various types of computing activities may be designated as approved or unapproved. It will be understood that the computing activities designated as approved or unapproved may depend on the setting in which the activity monitor is used and the selective preferences of the observers that utilize the activity monitors to monitor computing activities.

One setting may be, for example, the classroom setting where instructors utilize activity monitors 200 in order to monitor when students engage in computing activities that are unrelated to classroom instruction. Approved computing activity, in this example, may include the use of software applications for taking notes (e.g., word processing applications) and the use of network resources that supplement classroom instruction (e.g., file servers or websites). Unapproved activities, in this example, may thus include the use of software applications or network resources unrelated to classroom instruction.

As an example, some types of network access may be approved—e.g., accessing resources located on the local area network of the educational institution, which supplement classroom instruction—and some types of network access may be unapproved—e.g., browsing the Internet. As another example, some types of web browsing may be approved—e.g., accessing Internet websites that supplement classroom instruction—and some types of web browsing may be unapproved—e.g., accessing Internet websites unrelated to classroom instruction.

Additionally, some types of software applications may be approved—e.g., word processing applications, email applications, and other software applications related to classroom instruction—and other types of software applications may be unapproved—e.g., web browsing applications, instant messaging applications, and other software applications unrelated to classroom instruction.

The host driver 242 may employ a variety of techniques to monitor the computing activities occurring at the computing device 202 and determine whether those computing activities are approved or unapproved. As discussed above, the host driver 242 may monitor active software applications and networking activities at the computing device 202.

The host driver 242 may monitor the software applications that are active at the computing device by monitoring a process list maintained by the operating system 244 of the computing device 202. Operating systems typically maintain a list of running processes at a computing device, and the host driver 242 may examine the process list to identify approved and unapproved software applications. The host driver 242 may identify approved and unapproved software applications based on, for example, the name of the executable file for a software application, the program libraries accessed by a software application, or the titles of active windows for a software application. The host driver 242, in this example, may examine the process list at a periodic interval (e.g., once a second) to determine whether the active software applications are approved or unapproved.

The host driver 242 may monitor the networking activities occurring at the computing device by querying the operating system 244 for information related to one or more network adapters 210 and network requests at the computing device 202. Operating systems typically provide programmatic interfaces for determining the status of network adapters at a computing device, e.g., whether the network adapters are enabled/disabled or connected/disconnected. Operating systems also typically provide programmatic interfaces for examining networks requests received at or transmitted from a computing device.

The host driver 242, in this example, may query the operating system 244 at the computing device 202 to determine whether the network adapter 210 is enabled or disabled and connected or disconnected. If all network-related activities are designated as unapproved computing activities, the host driver 242 may determine that the computing device 202 is in an approved activity state when the network adapter 210 is disabled, and the host driver may determine that the computing device is in an unapproved activity state when the network adapter is enabled. If access to some networks is designated as approved (e.g., access to an internal LAN) and access to other networks is designated as unapproved (e.g., access to an external WAN such as the Internet), then the host driver 242 may determine that the computing device 202 is in an approved activity state when the network adapter 210 is connected to an approved network and that the computing device is in an unapproved activity state when the network adapter is connected to an unapproved network.

The host driver 242, in this example, may also register with the operating system 244 to receive notifications relating to inbound or outbound network requests. As mentioned above, the operating system 244 may insert the host driver 242 into the network stack so that the operating system may notify the host driver of network traffic occurring at the network adapter 210. The host driver 242 may determine that approved or unapproved networking activities are occurring at the computing device 202 based on information included in the network request such as, for example: a web domain—e.g., university.edu; a website address—e.g., www.website.com; a network address such as, for example, an IP (Internet Protocol) address—e.g., 223.125.47.99; or a network port number—e.g., port 80. The host driver 242 may determine that the computing device 202 is in an approved activity state when the network request includes an approved web domain, website address, network (e.g., IP) address, or port number. Likewise, the host driver 242 may determine that the computing device 202 is in an unapproved activity state when the network request includes an unapproved web domain, website address, network address, or port number.

As an example, web browsing may be designated as an unapproved computing activity while accessing email may be designated as an approved computing activity. The host driver 242, in this example, may distinguish between unapproved network requests for web browsing and approved network requests for accessing email based on the port numbers typically used for web browsing and email access. Web browsing typically uses ports 80 and 443 for HTTP requests (HyperText Transfer Protocol) and HTTPS requests (HTTP Secure) respectively. Email access typically uses ports 25, 110, and 143 for SMTP requests (Simple Mail Transfer Protocol), POP3 requests (Post Office Protocol), and IMAP requests (Internet Message Access Protocol) respectively. Accordingly, if a network request includes port numbers 80 or 443, then the host driver 242 may determine that unapproved web browsing activity is occurring at the computing device and thus determine that the computing device is in an unapproved activity state. Similarly, if a network request includes port numbers 25, 110, or 143, then the host driver 242 may determine that approved email access activity is occurring at the computing device and thus determine that the computing device is in an approved activity state. The host driver 242 may then transmit a signal 240 to the control module 228 of the activity monitor 200 corresponding to the activity state of the computing device 202, and the control module may activate the visual indicator 222, 224, or 226 that corresponds to the activity state of the computing device.

The host driver 242 may be configured to determine whether the computing activity occurring at the computing device 202 is approved or unapproved based on a set of rules (“rule set”). The rule set may include one or more rules that each designate an approved computing activity or unapproved computing activity. One example of a rule designates all web browsing activity as unapproved computing activity. Accordingly the host driver 242, in this example, may employ the rule set to ensure that no web browsing activity occurs at the computing device 202 while the activity monitor 200 is attached.

In one example implementation, the host driver 242 may be preconfigured (i.e., hardcoded) with the rule set. The host driver 242, in this example, may thus be installed “off-the-shelf” without subsequent configuration. The host driver 242 may be preconfigured using a configuration tool (not shown) that encodes the rule set in the host driver before the host driver is made available to the end users of the activity monitor 200. As mentioned above, the activity monitor 200 may be employed in a classroom setting. Accordingly, an administrator at the educational institution may selectively preconfigure the host driver 242 with a desired rule set using the configuration tool before distributing the host driver to the students.

In another example embodiment, the host driver 242 may be configured to access a configuration resource 246 as mentioned above with reference to FIG. 2. The configuration resource 246 may be, for example, a configuration file that includes the rule set 252, which designates the types of computing activities that are approved computing activities and unapproved computing activities. The configuration file 246, in this example, may reside at the computing device 202, and the host driver 242 may access the configuration file during the monitoring process to determine whether the computing activities occurring at the computing device are approved computing activities or unapproved computing activities. The configuration file 246 may be installed at the computing device 202 according to the same methods discussed above with regard to the installation of the host driver 242 at the computing device.

The configuration file 246 may also be updated periodically to provide an updated rule set 252. As an example, the computing device 202 may be coupled with a configuration server 254 via a network 214, and the configuration server may provide an updated configuration file 246 with an updated rule set 252 to the computing device. The host driver 242, in this example, may include the network address (e.g., IP address or website address) of the configuration server 254. Accordingly, the host driver 242 may be configured to automatically submit a request to the configuration server 254 to determine whether an updated configuration file 246 and rule set 252 is available. The host driver 242 may be configured to query the configuration server 254 for an updated configuration file 246 at a periodic interval (e.g., once a day) or, additionally or alternatively, whenever the activity monitor 200 is attached to the computing device 202. If the host driver 242 determines that an updated configuration file 246 is available, the host driver may automatically submit a request to download the updated configuration file from the configuration server 254. Alternatively, a user may update the configuration file 246 manually by, for example, inputting the network address of the configuration server 254 and manually requesting download of the updated configuration file.

To preserve the integrity of the configuration file 246 and to prevent a user from tampering with the rule set 252, the configuration file may be encrypted. The host driver 242 may decrypt the configuration file 246 during the monitoring process in order to access the rule set 252. The configuration file 246 may be encrypted and decrypted using, for example, a public key.

The rule set 252 may be referred to as a “whitelist” or a “blacklist.” A “whitelist” or “blacklist” may respectively indicate approved or unapproved computing activities. A whitelist may include a list of approved computing activities, and a blacklist may include a list of unapproved activities. The whitelist and blacklist may respectively indicate approved or unapproved computing activities by listing, e.g.: the names of the executable files for software applications; the program libraries accessed by software applications; the titles of windows for software applications; web domains; website addresses; network addresses; and network port numbers. It will be understood that additional or alternative information related to computing activity may be selectively included in order to identify the computing activities occurring at the computing device 202. The host driver 242 may compare a detected computing activity to the whitelist or blacklist in order to determine whether the computing activity is approved or unapproved and thus determine the activity state of the computing device 202. If a whitelist is employed, the host driver 242 may determine that the computing device 202 is in an unapproved activity state if the detected computing activity is not included in the whitelist. Likewise, the host driver 242 may determine that the computing device 202 is in an approved activity state if the detected activity is included in the whitelist. If a blacklist is employed, the host driver 242 may determine that the computing device is in an unapproved activity state if the detected computing activity is included in the blacklist. Similarly, the host driver 242 may determine that the computing device 202 is in an approved activity state if the detected activity is not included in the blacklist. It will be understood that the configuration file 246 may, in some example implementations, include features of both a whitelist and a blacklist.

The activity monitor 200 may also be configured to detect attempts to circumvent the activity monitoring process. Users may attempt to circumvent the monitoring process by, for example, operating the host driver 242 within a virtual machine, i.e., within a virtual runtime environment. Accordingly the host driver 242 may be configured to detect that it is operating within a virtual runtime environment. The host driver 242, in this example, may detect that it is operating within a virtual runtime environment by executing a set of machine instructions. The behavior of the machine instructions may depend on the operating system 244 and the processing module 204 of the computing device 202 as well as the virtual machine software. Accordingly the host driver 242, in this example, may determine whether it is operating within a virtual machine based on behavior of the machine instructions upon execution. If the host driver 242 detects that it is operating within a virtual runtime environment, the host driver may transmit a signal 240 to the activity monitor 200 to activate the unapproved visual indicator 226. It will be understood that various approaches may be selectively employed for determining whether the host driver 242 is operating within a virtual environment.

Users may also attempt to circumvent the monitoring process by detaching the activity monitor 200 upon activation of the unapproved visual indicator 226 and then reattaching the activity monitor so that the unknown visual indicator 222 is activated as the activity monitor attempts to reestablish the communication link. To prevent users from circumventing the monitoring process by repeatedly attaching and detaching the activity monitor 200, the activity monitor may be keep the unapproved visual indicator 226 activated for a predetermined countdown period as discussed above. The activity monitor 200, in this example, may keep the unapproved visual indicator activated even if the user reattaches the activity monitor to the computing device.

The host driver 242 may, for example, utilize the activity log 248 to reactivate the unapproved visual indicator 226 when the activity monitor 200 is reattached to the computing device 202 and the communication link is reestablished. Upon reattachment, the host driver 242 may examine the activity log 248 to determine the activity state of the computing device 202 at the time of detachment. The host driver 242 may compare the timestamp for the detachment event to the timestamp for the reattachment event. If the host driver 242 determines that the activity state was unapproved at the time of detachment and that the user reattached the activity monitor within the countdown period (e.g., 10 minutes), then the host driver may transmit a signal 240 to the activity monitor 200 to reactivate the unapproved visual indicator 226. In another example implementation, the activity monitor 200 and the host driver 242 may be configured to keep the unapproved visual indicator 226 activated until a password is entered at the computing device 202 by, e.g., the attending observer.

As mentioned above, the activity monitor 200 may also include an audio output device 234. The audio output device 234 may be employed, for example, to audibly indicate that the activity monitor 200 has been detached from the computing device 202. The audio output device 234 may emit a sound (e.g., a chirp) when the activity monitor 200 is detached from the computing device 202. The audio output device 234 may be powered by a capacitor (not shown) so that the audio output device may emit the sound despite the loss of power from the computing device 202 upon detachment of the activity monitor 200 from the computing device 202.

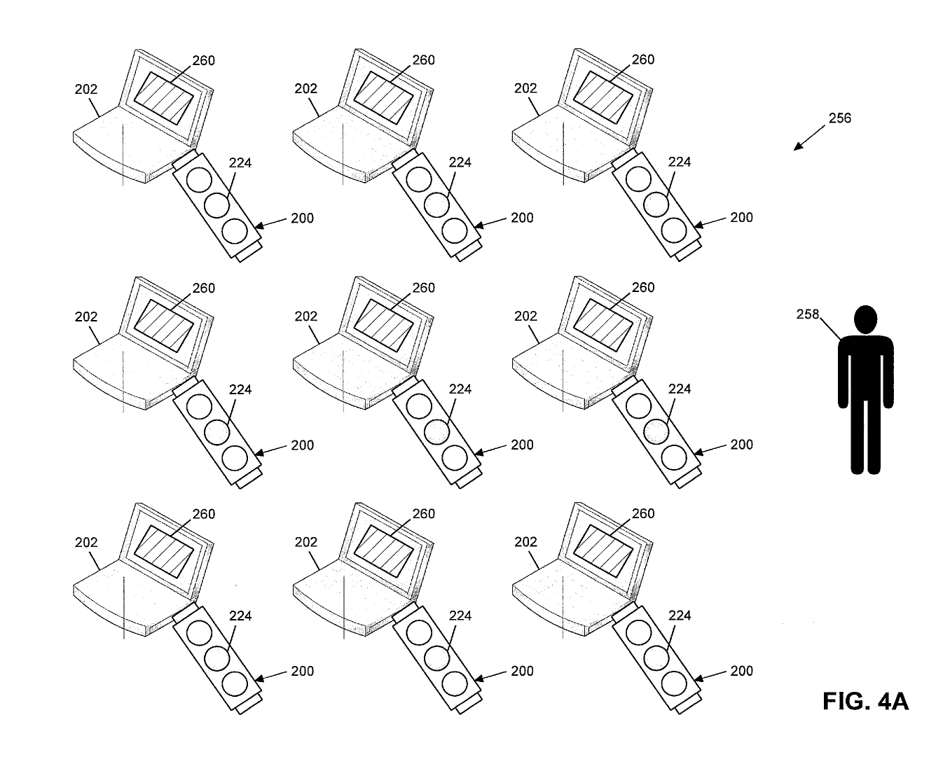

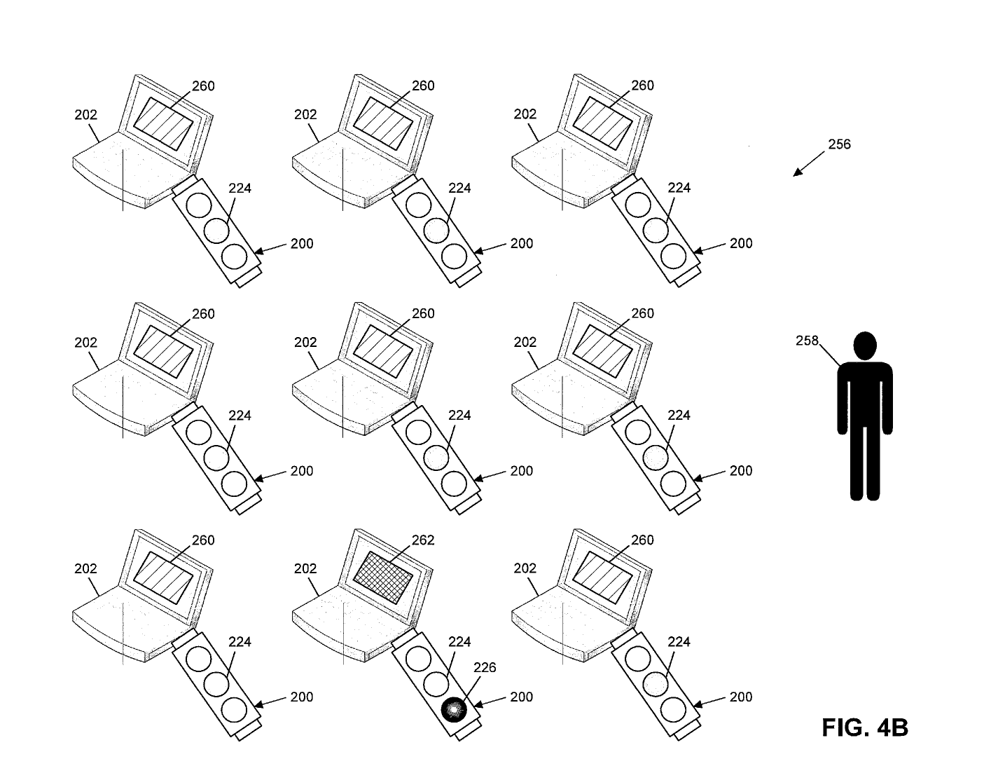

With reference to FIG. 4A and FIG. 4B, an example method of use of multiple activity monitors in the classroom setting 256 is shown. As seen in FIG. 4A, multiple computing devices 202 may be used to take notes during classroom instruction. Activity monitors 200 may be respectively provided to the students who may then attach the activity monitors to their respective computing devices 202. As seen in FIG. 4A, each of the activity monitors 200 indicate that approved activity is occurring at the computing devices via the approved visual indicators 224. An instructor 258 in the classroom setting 256 may observe the activity monitors 200 from a distance and conclude that each student is thus engaging in approved computing activities such as, for example, taking notes using a word processing software application 260.

If one of the students, however, engages in unapproved computing activity, the activity monitor 200 attached to the computing device 202 for the student may activate the unapproved visual indicator 226 as shown in FIG. 4B. As an example, web browsing activity may be designated as an unapproved computing activity. The host driver 242 at the computing device 202 may be configured to detect web browsing activity by detecting the execution of a web browsing software application. When a web browsing software application 262 is executed as seen in FIG. 4B, the host driver 242 may transmit a signal 240 to the activity monitor 200, and the activity monitor may deactivate the approved visual indicator 224 and activate the unapproved visual indicator 226. The instructor 258 may observe that the unapproved visual indicator 226 is activated and thus conclude that the student is engaging in unapproved computing activities.

As seen in FIG. 4A and FIG. 4B, the activity monitors 200 advantageously provide a quick and effective way to determine whether the computing activities occurring at the computing devices 202 are approved computing activities or unapproved computing activities. Where green lights are employed for the approved visual indicators 224 to visually communicate approved computing activities, the instructor 258 may perform a quick visual scan of the classroom setting 256 to assess the computing activities of each computing device 202. If the instructor 258 observes, in this example, a field of green lights, then the instructor may conclude that each student is engaging in approved computing activities at their respective computing devices 202. If, however, the instructor 258 observes a discontinuity in the field of green lights such as a blinking or solid red light, then the instructor may easily identify a student that is engaging in unapproved computing activities at the computing device 202. In this way, the instructor 258 may advantageously discourage computing activities that distract and detract from classroom instruction.

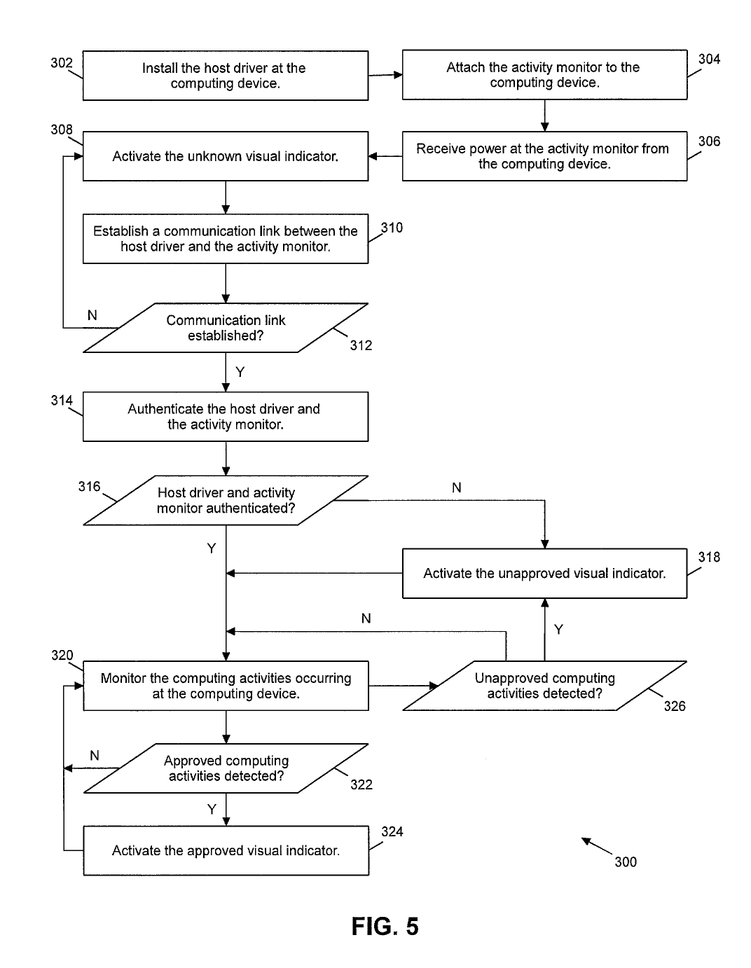

Referring now to FIG. 5, a flowchart 300 of example method steps for monitoring the computing activity occurring at a computer device is shown. First, a driver module (“host driver”) is installed at the computing device (step 302). The host driver may be installed according to one of the approaches set forth above with reference to FIG. 2. The host driver communicates with the operating system of the computing device to monitor the computing activities occurring at the computing device (e.g., active software applications and network requests), determine whether the computing activities are approved computing activities or unapproved activities, and transmit signals to an activity monitor that correspond to the approved or unapproved activity state of the computing device.

Once the host driver is installed at the computing device, the computer activity monitoring device (“activity monitor”) is attached to the computing device (step 304). The activity monitor includes a connector (e.g., a USB connector) that attaches to an I/O port of the computing device (e.g., a USB port). The activity monitor and the host driver exchange signals via the connector and the I/O port. When the activity monitor is attached to the computing device, the activity monitor receives power from the computing device (step 306). Upon receipt of power from the computing device, the activity monitor may activate an unknown visual indicator (step 308) as the activity monitor attempts to establish a communication link with the computing device, in particular the host driver residing at the computing device (step 310). If a communication link cannot be established between the activity monitor and the host driver (step 312), then the activity monitor may activate the unknown visual indicator (step 308) to indicate that a problem exists with establishing a communication link between the activity monitor and the host driver at the computing device, e.g., that the activity monitor is damaged. As discussed above, the unknown visual indicator may be, for example, an LED such as, e.g., a yellow LED.

If a communication link is successfully established between the activity monitor and the host driver at the computing device, then the activity monitor and the host driver may perform an authentication procedure to authenticate one another (step 314). If the host driver or activity monitor cannot be authenticated (step 316), then the activity monitor may activate the unapproved visual indicator (step 318) to indicate that the authentication procedure failed. Activating the unapproved visual indicator when the authentication procedure fails may visually communicate that a problem exists with the host driver or activity monitor, e.g., that the host driver is not installed at the computing device or that the host driver installed at the computing device has been tampered with.

If the authentication procedure succeeds (step 316), then the host driver begins monitoring the computing activities occurring at the computing device (step 320). As discussed above, the host driver communicates with the operating system of the computing device to monitor the computing activities that occur, and the host driver may update an activity log that resides at the computing device during the monitoring process. If the host driver determines that approved computing activities are occurring at the computing device (step 322), then the host driver may transmit to the activity monitor a signal that corresponds to an approved activity state, and the activity monitor may activate the approved visual indicator in response to receipt of the signal corresponding to the approved activity state (step 324). As discussed above, the approved visual indicator may be, for example, a green LED. The host driver continues to monitor the computing activities (step 320) after the host driver transmits the signal corresponding to the approved activity state to the activity monitor. Also discussed above, the host driver may periodically transmit to the activity a signal corresponding to an approved activity state as the host driver periodically determines that approved computing activities are occurring at the computing device in order to ensure the approved visual indicator remains activated.

If the host driver determines, however, that unapproved computing activities are occurring at the computing device (step 326), then the host driver may transmit to the activity monitor a signal that corresponds to an unapproved activity state, and the activity monitor may activate the unapproved visual indicator in response to receipt of the signal corresponding to the unapproved activity state (step 318). The activity monitor may keep the unapproved visual indicator activated for a predetermined countdown period as also discussed above. The host driver continues to monitor the computing activities (step 320) after the host driver transmits the signal corresponding to the approved activity state to the activity monitor.

The host driver may determine the activity state of the computing device (i.e., approved or unapproved) by comparing observed computing activities to, e.g., a configuration resource that also resides at the computing device. As discussed above, the configuration resource may be a whitelist or blacklist of, e.g., software applications, web domains, websites, network addresses, and network ports. Accordingly, the host driver may transmit the signals to the activity monitor based on the comparison of the observed computing activities to the computing activities listed in the configuration resource.

Additionally, the host driver may encrypt the signals transmitted to the activity monitor, and the activity monitor may decrypt the signals received from the host driver when activating the approved or unapproved visual indicator. Further, the activity monitor may emit a sound at an audio output device when the activity monitor is detached from the computing device. Moreover, the activity monitor may be configured to activate the visual indicators according to a selective lighting pattern, e.g., a solid lighting pattern, a blinking lighting pattern, or a combination of solid and blinking lighting patterns.

It will be understood and appreciated that one or more of the processes, sub-processes, and process steps described in connection with FIGS. 1-5 may be performed by hardware, software, or a combination of hardware and software on one or more electronic or digitally-controlled devices. The software may reside in a software memory (not shown) in a suitable electronic processing component or system such as, for example, one or more of the functional systems, devices, components, modules, or sub-modules schematically depicted in FIGS. 1-5. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module (e.g., the processing module 204 of FIG. 1 and the control module 228 of FIG. 2), which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the computing device 202 or activity monitor 200), direct the electronic system to carry out the instructions. The computer program product may be selectively embodied in any non-transitory computer-readable storage medium for use by or in connection with an instruction execution system, apparatus, or device, such as a electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program can be electronically captured via, for instance, optical scanning of the paper or other medium, then compiled, interpreted, or otherwise processed in a suitable manner if necessary, and then stored in a computer memory or machine memory.

It will also be understood that the term “coupled” as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A monitoring device for indicating computing activities occurring at a computing device comprising:
a control module that receives signals from the computing device, the signals correspond to an activity state of the computing device;
a first visual indicator coupled to the control module, the control module activates the first visual indicator in response to receipt of a signal corresponding to an approved activity state; and
a second visual indicator coupled to the control module, the control module activates the second visual indicator in response to receipt of a signal corresponding to an unapproved activity state.

2. The monitoring device of claim 1 further comprising a third visual indicator coupled to the control module, the control module activates the third visual indicator when the activity state of the computing device cannot be determined.

3. The monitoring device of claim 2 wherein:
the first visual indicator is a green light-emitting diode;
the second visual indicator is a red light-emitting diode; and
the third visual indicator is a yellow light-emitting diode.

4. The monitoring device of claim 1 wherein:
the control module receives the signals from a driver module that resides at the computing device;
the driver module monitors the computing activities occurring at the computing device and determines whether the computing activities are approved computing activities or unapproved computing activities;
the driver module transmits to the control module a signal corresponding to an approved activity state in response to a determination that the computing activities are approved computing activities; and
the driver module transmits to the control module a signal corresponding to an unapproved activity state in response to a determination that the computing activities are unapproved activities.

5. The monitoring device of claim 4 wherein:
the control module attempts to authenticate the driver module when the monitoring device is attached to the computing device; and
the control module activates the second visual indicator when the control module cannot authenticate the driver module.

6. The monitoring device of claim 4 wherein the computing activities monitored by the driver module include at least one computing activity selected from the group consisting of:
operation of one or more predetermined software applications at the computing device;
operation of one or more network adapters at the computing device;
access of one or more predetermined network addresses;
access of one or more predetermined web domains;
access of one or more predetermined websites; and
access of a network using one or more predetermined network ports.

7. The monitoring device of claim 1 wherein the control module, the first visual indicator, and the second visual indicator are contained within a housing and further comprising:
a connector coupled to the control module wherein the connector is attachable to an input-output (I/O) port of the computing device such that the control module receives the signals from the computing device via the I/O port and connector.

8. The monitoring device of claim 7 wherein the connector is a universal serial bus (USB) connector.

9. The monitoring device of claim 1 further comprising an audio output device that emits a sound when the monitoring device is detached from the computing device.

10. The monitoring device of claim 1 wherein:
the signals received at the control module from the computing device are encrypted signals; and
the control module decrypts the encrypted signals when activating the first visual indicator or the second visual indicator.

11. A computer-implemented method of indicating computing activities occurring at a computing device comprising:
receiving signals from the computing device that correspond to an activity state of the computing device;
automatically activating a first visual indicator in response to receipt of a signal corresponding to an approved activity state; and
automatically activating a second visual indicator in response to receipt of a signal corresponding to an unapproved activity state.

12. The computer-implemented method of claim 11 further comprising activating a third visual indicator when the activity state of the computing device cannot be determined.

13. The computer-implemented method of claim 11 further comprising:
monitoring the computing activities occurring at the computing device;
determining whether the computing activities are approved computing activities or unapproved computing activities;
transmitting a signal corresponding to an approved activity state in response to a determination that the computing activities are approved computing activities; and
transmitting a signal corresponding to an unapproved activity state in response to a determination that the computing activities are unapproved computing activities.

14. The computer-implemented method of claim 13 further comprising:
establishing a communication link with the computing device;
performing an authentication procedure when the communication link is established; and
activating the second visual indicator when the authentication procedure fails.

15. The computer-implemented method of claim 14 further comprising emitting a sound at an audio output device when the communication link is lost.

16. The computer-implemented method of claim 13 wherein monitoring the computing activities at the computing device includes at least one of:
monitoring operation of one or more predetermined software applications at the computing device;
monitoring operation of one or more network adapters at the computing device;
monitoring access of one or more predetermined network addresses;
monitoring access of one or more predetermined web domains;
monitoring access of one or more predetermined websites; and
monitoring access of a network using one or more predetermined network ports.

17. The computer-implemented method of claim 11 further comprising receiving the signals from the computing device via a universal serial bus (USB) connector.

18. The computer-implemented method of claim 11 wherein the signals received from the computing device are encrypted signals and further comprising decrypting the encrypted signals when activating the first visual indicator or the second visual indicator.

19. A monitoring device for indicating the computing activities occurring at a computing device comprising:
a microcontroller that receives signals from a driver module that resides at the computing device, the driver module monitors the computing activities occurring at the computing device, determines an activity state of the computing by determining whether the computing activities are approved computing activities or unapproved computing activities, and transmits to the microcontroller a signal corresponding to the activity state of the computing device;
a connector coupled to the microcontroller wherein the connector is attachable to an input-output (I/O) port of the computing device such that the microcontroller receives the signals from the driver module via the I/O port and the connector;
a first light-emitting diode coupled to the microcontroller, the microcontroller activates the first light-emitting diode in response to receipt of a signal corresponding to an approved activity state such that the first light-emitting diode visually communicates to an observer that approved computing activities are occurring at the computing device;
a second light-emitting diode coupled to the microcontroller, the microcontroller activates the second light-emitting diode in response to receipt of a signal corresponding to an unapproved activity state such that the second light-emitting diode visually communicates to the observer that unapproved computing activities are occurring at the computing device;
a third light-emitting diode coupled to the microcontroller, the microcontroller activates the third light-emitting diode when the activity state of the computing device cannot be determined; and
an audio output device that emits a sound when the monitoring device is detached from the computing device.
